(19) United States
(12) Patent Application Publication
(10) Pub. No.: US 2015/0016007 A1
(43) Pub. Date: Jan. 15, 2015

(54) Safety Relay Circuit

(71) Applicant: Phoenix Contact GmbH & Co. KG, Blomberg (DE)

(72) Inventor: Fabian Zink, Detmold (DE)

(21) Appl. No.: 14/380,579

(22) PCT Filed: Mar. 12, 2013
(86) PCT No.: PCT/EP2013/055029

§ 371 Date: Aug. 22, 2014

(30) Foreign Application Priority Data
Mar. 13, 2012 (DE) 102012004843.2

(51) Int. Cl. H01H 47/00

(52) U.S. Cl. CPC H01H 47/00
USPC 361/170

(57) ABSTRACT

Safety relay circuit, in particular, comprising two series-connected or parallel-connected relay switches (k1, k2) in a load current circuit (LN). The relay switch (k1) is assigned a switch position indicator circuit (A1). An evaluation circuit compares the command input to the relay (k1) with the display of the indicator circuit (A1), so that any fault states that may occur at the relay switches can be detected.

### FIELD OF THE INVENTION

The invention relates to a circuit arrangement for switching a load current circuit in fail-safe technology, wherein the objective of the invention is to be able to detect the fault states of the relay. In particular, the objective of the invention is to ensure the de-energization of the load current circuit (“switch-off safety relay circuit”) or the energization of the load current circuit (“switch-on safety relay circuit”).

### BACKGROUND OF THE INVENTION

In order to be able to maintain the opening position of a load current circuit in a safe and reliable way, it is preferred that electromagnetic relays be used. In fail-safe technology the switching position of the mechanical switching contacts is checked. In this case it is known from the prior art (EP 1 202 313 A1) to apply a high frequency signal to the monitoring circuit with the switch to be checked and to determine the position of the switch with a high frequency detector. In order to enhance the safety, it is also already known to arrange two relay switches one after the other in the load current circuit. However, checking the position of the switch by means of a high frequency monitoring circuit is complicated and cannot detect certain fault states. Hence, the relay switch can take its open position, which can be detected, but, when the situation arises that a foreign body or a metal fracture forms a bridge between the working contact and the normally closed contact of the relay switch, this fault state cannot be determined with the known device.

### SUMMARY OF THE INVENTION

The object of the present invention is to provide a safety relay circuit, with which the fault states in the relay switch can be accurately determined. In particular, the objective of the present invention is to ensure that it is possible to de-energize the load current circuit or to energize the load current circuit.

The invention provides a monitoring circuit, which logically interconnects the command input to an electromechanical relay with a circuit, which indicates the position of the relay switch or the state of the relay switch, and obtains therefrom a fault/no fault signal.

In order to ensure that the load current circuit is de-energized, the invention provides that the relay switches of two relays are connected in series in the load current circuit. If, then, one of the switches does not reach its open state, the other relay switch will affect, nevertheless, that the current path to the load has been de-energized.

In order to ensure that the load current circuit is energized, the invention provides that the relay switches of two relays in the load current circuit are connected in parallel to each other. If, then, one of the switches does not reach its closed state, the other relay switch will affect, nevertheless, that the current path to the load is closed.

In accordance with fail-safe technology it has to be demanded that faults be determined, even if they do not lead directly to a faulty circuit, because the fault in one of the relay switches is remedied by the proper functioning of the other relay switch. Each relay switch is provided with an indicator circuit that, however, is able to detect faults owing to faulty bridging in the relevant relay switch by means of current detection means.

In the preferred embodiment each indicator circuit comprises a light emitting diode, which is operated by means of an assigned auxiliary voltage source. In the open position of a respective relay switch, the associated light emitting diode goes fully on and, in so doing, signals the correct state of the switch in the quiescent state of the circuit. If, in contrast, the load current circuit is switched to active mode and the relay switches do not exhibit any faults, then the light emitting diodes are switched off.

If one of the series-connected relay switches in the switch-off safety relay circuit were not to drop off when the load current circuit is de-energized, for example, because the contacts are welded together, then the associated indicator circuit is not closed and the associated light emitting diode stays off. This situation is detected as a fault in the respective relay, and it is possible to prevent the load current circuit from being energized again.

If upon activating the load current circuit a fault in one of the relays in the switch-off safety relay circuit occurs in such a way that all three terminal contact points of the defective relay switch are electrically connected to each other, then the assigned light emitting diode flashes owing to its being operated by means of the auxiliary voltage source and there is the possibility of disconnecting the load current circuit by switching over the non-defective relay. Such a procedure can take place within a safety margin.

A fault in the switch-off safety relay circuit can also develop when the load current circuit is de-energized, i.e. that the current flow of the auxiliary power source is disrupted in one of the indicator circuits and the light emitting diode does not glow correctly. As a result, it is possible to detect that the relevant relay is no longer safe. It is possible to prevent the load current circuit from being energized.

If one of the relay switches in the switch-on safety relay circuit were to be connected by welding to the contact point of the monitoring circuit (“hanging contacts”) or if a “three point contact bridge” were to occur at one of the relay switches, then this situation is detected when querying the indicator circuit because the light emitting diode goes on. The safe switch-on state of the load current circuit is maintained by means of the non-defective relay that is connected in parallel.

If the switchless contacts in one of the relay switches in the switch-on safety relay circuit are bridged in a faulty way (“two point contact bridge”), then this situation will be detected when the defective relay is switched on. Under some circumstances the load current can lead to an excessive load on the current detection means, a drawback that can be averted by means of a fuse (“polyfuse”).

### BRIEF DESCRIPTION OF THE DRAWINGS

Some exemplary embodiments of the invention are described with reference to the drawings. The drawings show in:

FIG. 1 a safety relay circuit in the quiescent state.

FIG. 2 a safety relay circuit in the active state.

FIG. 3 a safety relay circuit in the fault state I (hanging or welded contacts).

FIG. 4 a safety relay circuit in the fault state II (three point contact bridge).

FIG. 5 a safety relay circuit in the fault state III (two point contact bridge).

FIG. 6 a switch-off safety relay circuit according to the invention.

FIG. 7 a schematic representation of the indicator circuits of the switch-off safety relay circuit in the quiescent state of the load current circuit.

FIG. 8 the switch-off safety relay circuit in the active state of the load current circuit.

FIG. 9 the switch-off safety relay circuit in a fault state I.

FIG. 10 the switch-off safety relay circuit in a fault state II.

FIG. 11 the switch-off safety relay circuit in a fault state III.

FIG. 12 a schematic representation of the monitoring circuits of the switch-on safety relay circuit in the quiescent state of the load current circuit.

FIG. 13 the switch-on safety relay circuit in the active state of the load current circuit.

### DETAILED DESCRIPTION

To begin with, reference is made to the FIGS. 1 to 5, which show a safety circuit in various correct and faulty states. The safety circuit comprises a load current circuit LN between the terminals L and N. In this case the load current circuit can be energized and de-energized by a relay K1. The safety circuit also comprises an indicator circuit A1, which indicates the position of the switch of the relay, and an evaluation circuit, which logically interconnects the indicator state of the indicator circuit A1 with the command input to the relay K1 and therefrom evaluates the state of the whole circuit arrangement as “faultless” or as “defective.” It is also possible to refer to the indicator circuit together with the evaluation circuit as a monitoring circuit.

The relay K1 comprises, as an electromechanical relay, a switch tongue k1, which switches between a normally open contact point S1 and a normally closed contact point Ö1 and is connected to a common point G1. The indicator circuit A1 comprises an auxiliary current source H1 and a current detection means in the form of a light emitting diode LED1 and is connected to the switching points G1 and Ö1. Depending on the position of the switch k1, the light emitting diode LED1 is operating or is not operating. The ON state of the light emitting diode is marked by means of the arrows, while the arrows are omitted in the OFF state.

The evaluation circuit comprises an integrated circuit IC1, which can make logical interconnections in such a way that two similar input signals produce an output signal “faultless,” which in this embodiment is represented by a “0,” and two dissimilar input signals result in the output of an error signal, which in this case is symbolized by a “1.” On the one hand, the command input to the relay K1 and, on the other hand, the signal of an optocoupler is used as the input signal to the integrated circuit IC1. Said signal of an optocoupler converts the signal from the light emitting diode LED1 into a corresponding input signal to the integrated circuit IC1. The optocoupler consists of a circuit with a switching transistor Q1, which is switched on by means of the light from the light emitting diode LED1 and, otherwise, is switched off. In the circuit of the optocoupler there is a resistor, which is connected in series with the transistor Q1, and a tap leads the signal of the optocoupler to the integrated circuit IC1 of the evaluation circuit.

FIG. 1 shows the faultless state of the safety relay circuit in the quiescent state. The relay K1 has de-energized the load current circuit LN and has energized the indicator circuit A1. The light emitting diode LED1 lights up and connects through the transistor Q1, so that the optocoupler emits the signal “0.” This state is consistent with the command signal “0” to the relay K1. Thereupon the integrated circuit IC1 emits the faultless signal “0.”

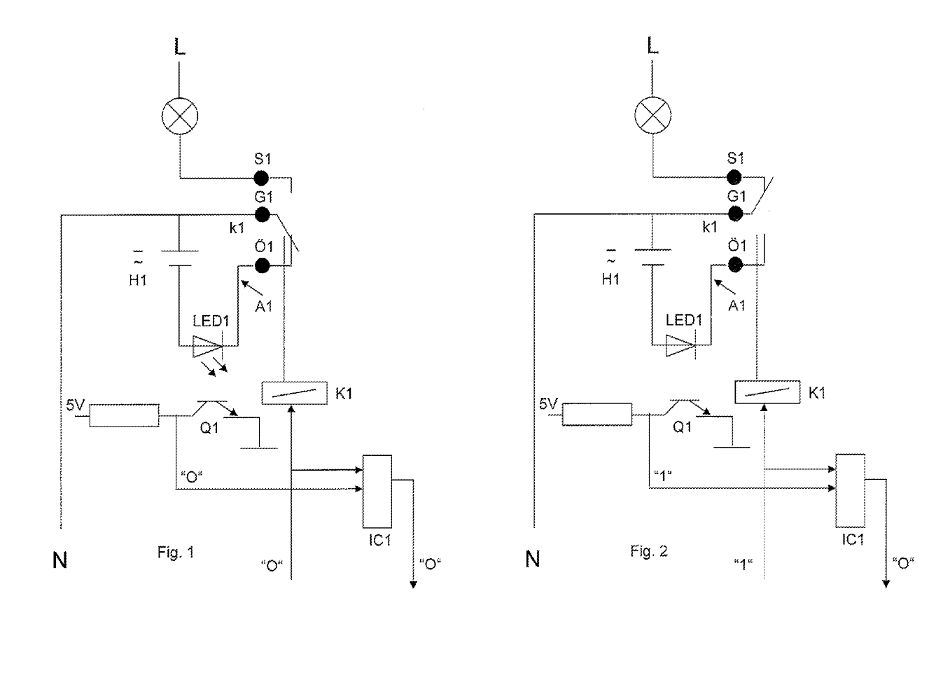

FIG. 2 shows the active state of the safety relay circuit. With the signal “1” a switch-on command is given to the relay K1, which energizes the load current circuit LN and de-energizes the indicator circuit A1. Then the optocoupler will no longer receive an illumination signal and forwards the signal “1” to the integrated circuit IC1. Since both inputs of the integrated circuit IC1 of the evaluation circuit are identical in value, the signal “faultless,” symbolized by “0,” is emitted.

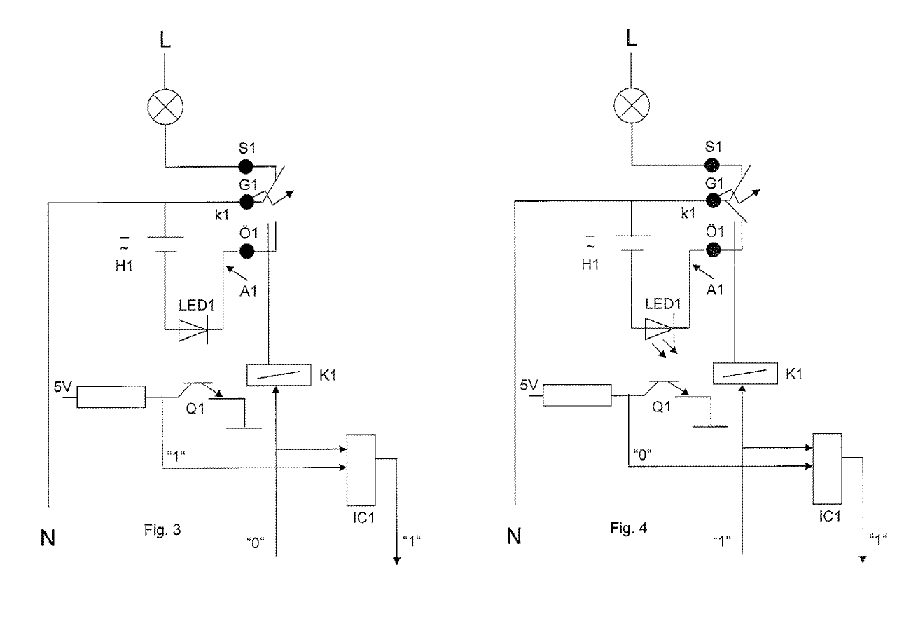

FIG. 3 show a fault state I, which can be characterized by the hanging or welded contacts. This fault state I occurs when the relay K1 is disconnected and means that the relay is no longer safe. Owing to the faulty position of the switch tongue k1, the diode LED1 in the indicator circuit A1 does not glow, so that the optocoupler outputs the signal “1” to the integrated circuit IC1, which detects the discrepancy between the command input to the relay K1 and the reaction of the indicator circuit A1 and emits “1” as the error signal.

FIG. 4 shows a fault state II, which can be referred to as a “three point contact bridge,” because the switching points S1, G1 and Ö1 are in contact with each other. In the fault state II the diode LED glows. When the relay K1 is switched on with the command signal “1,” the indicator circuit A1 should open, but this does not occur due to the three point contact bridge. This situation leads to a discrepancy between the input signals of the integrated circuit IC1 and, thus, to an output of an error signal “1.”

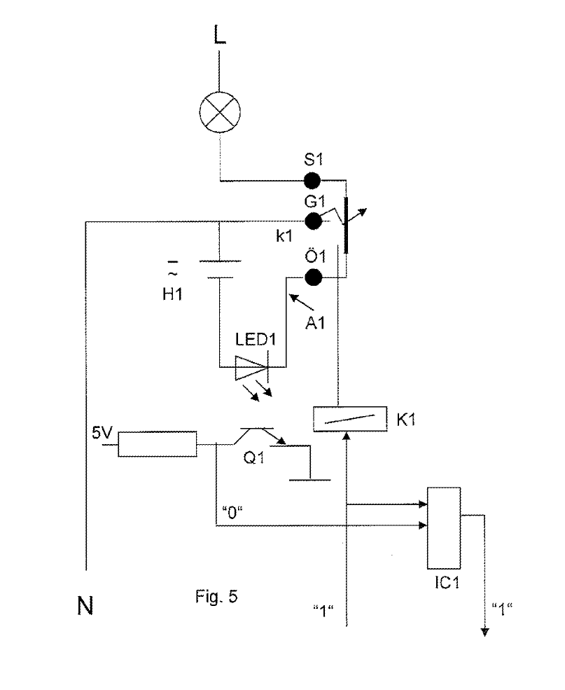

FIG. 5 shows a fault state III, which is in the manner of a two point contact bridge. During ongoing operations, when the indicator circuit A1 should be de-energized, the light emitting diode LED 1 receives an overcurrent, which is diminished by means of a protective resistor, which is not shown. The light that is emitted as a result allows the optocoupler to output the signal “0,” which is detected by the integrated circuit IC1. There is a discrepancy between the input signal “1” to the relay K1 and the signal “0” of the indicator circuit A1, which can be evaluated for the error message. It is also possible to utilize the changeover between the momentary flash of the light emitting diode and the extinction of the light emitting diode in the evaluation circuit, which would occur if the light emitting diode were destroyed, as an error message.

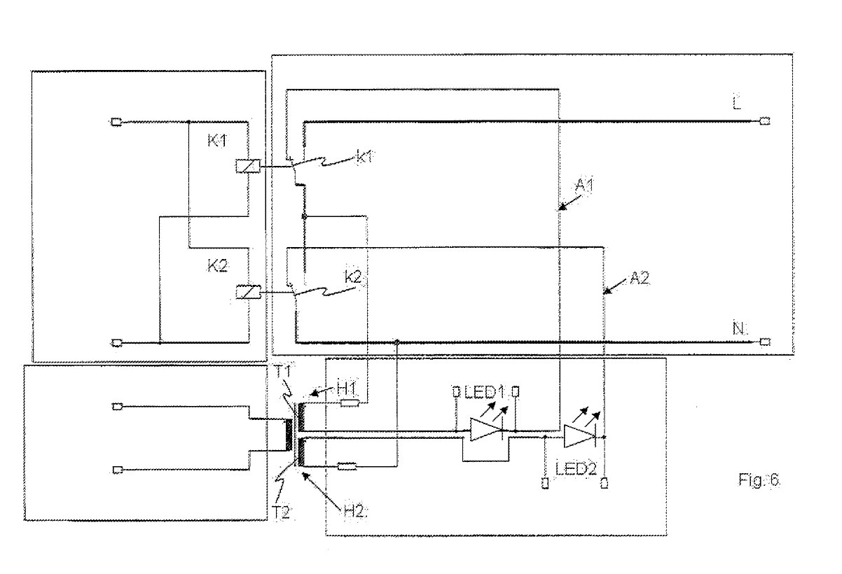

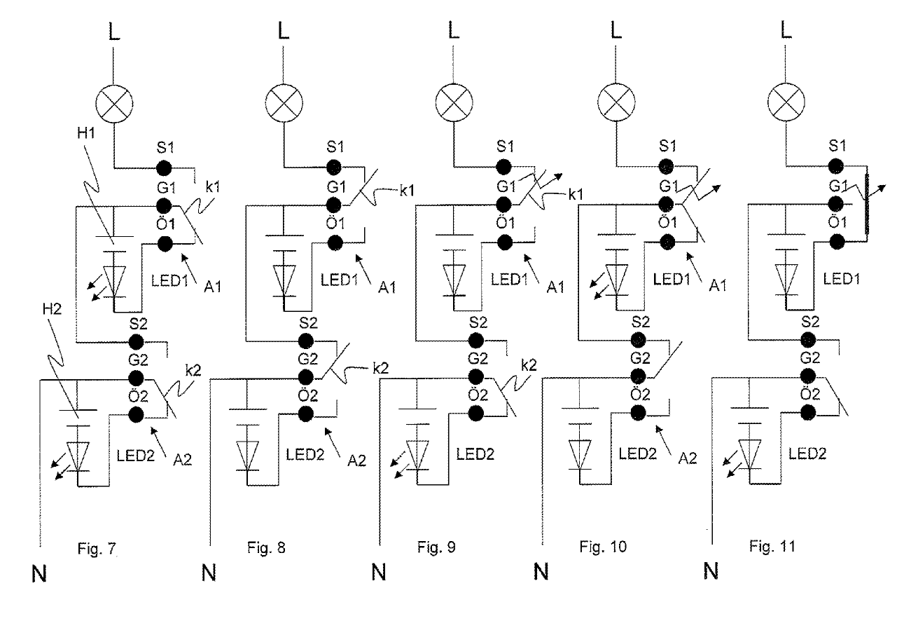

The circuit arrangement, which is shown in FIG. 6, can be described as a safety relay with optical diagnostics. The circuit comprises two electromagnetic relays K1 and K2 of a simple, conventional design. Said two electromagnetic relays, which are connected in parallel to each other, are connected to a control source, which is not shown, so that the relay coils are or are not excited. It is also possible to drive the relays K1 and K2 by means of separate control current circuits. Each of the relays K1 and K2 comprises an assigned switch k1 and k2 respectively, which can take an idle position, as shown in FIG. 7, and a working position (FIG. 8), as a function of the excited state of the relay coils. In their working position the relay switches k1 and k2 close a load current circuit, which extends between the terminals L and N. Each relay switch k1, k2 is assigned an indicator circuit A1 or A2 respectively, each of which indicates the position of the switches k1 or k2 respectively, and each of which has a light emitting diode LED1 or LED2 respectively as the current detection means, as well as a respective auxiliary voltage source H1, H2 for operating the respectively assigned light emitting diode. The relay switch k1 in the illustrated idle position (FIG. 7) bridges the otherwise open indicator circuit A1 at two (G1, Ö1) of the three terminal contact points (S1, G1, Ö1) of the relay K1, and the switch k2 connects in the same way the corresponding terminal contact points (S2, G2, Ö2) of the relay K2, in order to close the second indicator circuit U2. When the relay switches k1 and k2 are switched from their illustrated idle position (FIG. 7) into the working position (FIG. 8), the indicator circuits A1 and A2 are opened, and the load current circuit LN is closed.

Any type of current source, with which the current detection means and, in particular, the light emitting diodes can be operated, can be used as the auxiliary voltage source H1, H2. In the case of the circuit according to FIG. 6, a transformer having a primary winding and two secondary windings is used as the auxiliary voltage sources H1, H2. The transformer forms a first transformer T1 as the first auxiliary voltage source H1 and forms a second transformer T2 as a second auxiliary voltage source H2. Voltage pulses are applied to the primary winding, in order to allow the respective auxiliary voltage sources H1, H2 to become intermittently effective and, in so doing, to query the respective state of each of the indicator circuits A1, A2.

FIG. 7 shows a schematic diagram of the switch-off safety relay circuit in the quiescent state. The auxiliary voltage sources H1, H2 are shown in a simplified form as DC voltage sources. The terminal contact points are marked with the reference symbols S1, G1 andÖ1 or S2, G2 andÖ2. The first relay switch k1 closes the first indicator circuit A1 between the contact points G1 andÖ1, and the second relay switch S2 closes the second indicator circuit A2 between the contact points G2 andÖ2. The arrows at the light emitting diodes LED1 and LED2 indicate the illumination state of these diodes. If both diodes go fully on, then the conditions for a fault state are not met when the load current circuit is de-energized, as explained above with reference to FIG. 1.

FIG. 8 shows the switch-off safety relay circuit in its active state, in which the load current circuit LN is energized. The switch k1 connects the contact points S1 to G1, and the switch k2 connects the contact points S2 to G2. At the same time the indicator circuits A1 and A2 are open, and the light emitting diodes LED 1 and LED2 do not flash. Therefore, the conditions for a faultless active state are met, as explained above with reference to FIG. 2.

A fault state I (“hanging contacts”) at the switch k1 is explained with reference to FIG. 9. Whereas the switch k2 has gone into the idle state when the load current circuit is disconnected, the switch k1 is stuck at the contact point S1 (for example, due to welded contacts). As a result, the first indicator circuit A1 has stayed open, and the light emitting diode LED1 does not flash. This fault state I can be detected, as explained in detail with reference to FIG. 3. In addition, the discrepancy between the illumination states of the LED1 and LED2 can be detected as a fault. It is possible to prevent the load current circuit from restarting again.

FIG. 10 shows in schematic form an additional fault state II (“three point contact bridge”), which can become apparent when the load current circuit LN is energized. The fault occurs due to a short circuit between the contact points S1, G1 and Ö1, for example, when a spring in the relay is broken. How this fault state II can be detected is explained with reference to FIG. 4. In order to discover the fault, it is also possible to exploit the fact that in the case of this fault the light emitting diode LED1 of the indicator circuit A1 will glow, while the light emitting diode LED2 of the indicator circuit A2 extinguishes. When this fault occurs, the load current circuit should be immediately de-energized. It is also possible to immediately disconnect said load current circuit by means of the relay K2.

FIG. 11 shows a fault state III (“two point contact bridge”). In this case the fracture of a metal part has caused the contact points S1 and Ö1 to become connected to each other. This situation can be detected before the load current circuit is connected to the system, because in the quiescent state of the circuit (FIG. 7) both light emitting diodes LED 1 and LED2 should flash, but in the fault state III, the LED 1 goes out. Then the load current circuit should not be energized. If the fault state III occurs while the system is in operation, then this fault will be detected in accordance with the procedure according to FIG. 5.

Therefore, the above described circuit arrangement comprises a monitoring circuit, which has the indicator circuits A1, A2 and the evaluation circuits according to the FIGS. 1 to 5. In this case the integrated circuits, which are assigned to the evaluation circuits A1, A2, can be combined with each other and can also include in an integrated fashion an additional logic circuit, in order to record and to evaluate by means of logical interconnections the positions of the relay switches k1, k2 and the response states of the light emitting diodes LED1, LED2 as well as to carry out, if required, safety circuit measures.

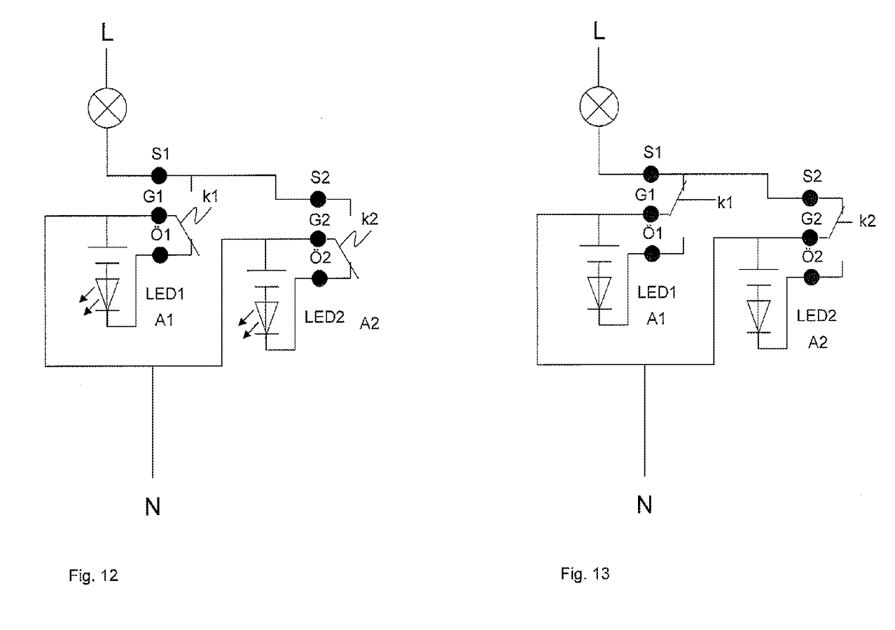

In order to implement the switch-on safety relay circuit, FIG. 6 is modified in such a way that the switches k1, k2 are parallel to each other in the load current circuit LN, which is also apparent from the FIGS. 12 and 13. If, thereafter, one of the switches k1 or k2 were to fail, then the other switch can ensure that the load current circuit is or remains safely energized.

In contrast to the switch-off safety relay circuit according to the FIGS. 7 to 11, it is preferred in the case of a switch-on safety relay circuit that the relays K1, K2 be operated in the non-energized state of the switches k1, k2, in order to energize the load current circuit LN. However, this is not mandatory, and in the FIGS. 12 and 13 the terminal contact points are provided with the same reference numerals as in the exemplary embodiment according to the FIGS. 6 to 11, on which said terminal contact points are based. FIG. 12 shows the quiescent state of the switch-on safety relay circuit, and FIG. 13 shows the active state of said switch-on safety relay circuit. In the quiescent state both light emitting diodes LED1 and LED2 of the two indicator circuits A1 and A2 flash, and in the active state of the switch-on safety relay circuit, the light emitting diodes LED1 and LED2 are dark.

As in FIG. 3, the fault state I of the relay K1 consists of the switch k1 being stuck at a contact point (in this case Ö1). This state can be determined according to the monitoring method, which was described with reference to FIG. 3. As an alternative or in addition, the fault state I (“hanging contact”) can be determined when querying the indicator circuits A1 and A2 due to the fact that the illumination states of the light emitting diodes LED1 and LED2 do not match. In this case the switch-on state of the load current circuit LN continues to be ensured by the switch S2.

In the fault state II (“three point contact bridge”) all three contact points S1, G1, Ö1 of the relay K1 are in electrical contact with each other. This situation can be determined in the same way as described with reference to FIG. 4. Furthermore, the fault state II can be detected when the relay K1 is energized, because the illumination states of the light emitting diodes LED1 and LED2 will be different.

In the fault state III (“two point contact bridge”) a bridge has been formed between the terminal contact points S1 and Ö1. This situation can be determined according to the method described above with reference to FIG. 5. In addition, there is the possibility of testing the fault on the basis of the varying intensity of the light emitted from the diodes LED1 and LED2. As long as the switch k2 of the relay K2 closes the current path of the load current circuit LN, the current has little reason to flow over the location of the fault at the relay K1. However, when the switch k2 is opened, the voltage that is applied could result in an excessive current through the diode LED1, so that it is advisable to protect the light emitting diodes by means of a fuse (“polyfuse”). The net result of the switch play of the switch k2 is that the diodes LED1 and LED2 exhibit different degrees of illumination, so that it is possible to detect that the relay K1 is no longer safe.

It is expedient to combine the two described methods for determining a fault together to form advantageously the control current circuit. In this case the control positions of the relay switches k1 and k2 and the response states of the diodes LED1 and LED2 are logically interconnected with each other, in order to detect the fault states of the respective relay switches k1, k2. The monitoring circuit, which is used for this purpose, can comprise the two indicator circuits A1, A2 and the assigned evaluation circuits as well as the additional logic circuits, in order to carry out the logical interconnections described above. It is expedient to combine the evaluation circuits and the additional logic circuits to form a common integrated circuit.

What is claimed is:

1. A circuit arrangement for switching a load current circuit in fail-safe technology, said circuit arrangement comprising:
at least one electromagnetic relay (K1) with a controlled switch (k1), which in the active state of the relay takes its closed working position and, in so doing, is located in the load current circuit (LN), while in the idle state of the relay the switch (k1) takes an open idle position with respect to the load current circuit (LN),
at least one monitoring circuit, which comprises:
a switch position indicator circuit (A1), which includes an auxiliary voltage source (H1) and current detecting means and in the idle state of the relay (K1) allows the current detection means to respond,
an evaluation circuit, which compares the response of the current detection means with the command input “on” or “off” to the relay (K1) and from the comparison derives the state of the circuit arrangement “faultless” or “defective,”
wherein in the faultless idle state the relay (K1) de-energizes the load current circuit (LN) and energizes the indicator circuit (A1),
wherein in the faultless active state the relay (K1) energizes the load current circuit (LN) and de-energizes the indicator circuit (A1),
wherein when the load current circuit (LN) is disconnected, a fault state “hanging contacts” can be detected by means of the discrepancy between the command input to the relay and the response state of the current detection means,
wherein when the load current circuit (LN) is connected up, a fault state “three point contact bridge” becomes apparent due to the discrepancy between the command input to the relay and the partially persisting response state of the current detection means, and
wherein during the ongoing operations a fault state “two point contact bridge” can be detected by means of the discrepancy between the command input to the relay and an incorrect response state of the current detection means.

2. The circuit arrangement, as claimed in claim 1:
wherein upon the switch-on command of the relay a logic command signal “1” is outputted to the evaluation circuit, and upon the switch-off command a logic command signal “0” is outputted to the evaluation circuit,
wherein in the positive response state of the current detection means a logic status signal “0” is generated, and in the negative response state, a status signal “1” is generated, and
wherein in the event that the status signal agrees with the command signal, the evaluation circuit indicates the absence of a fault, and in the event of non-agreement, the presence of a fault.

3. The circuit arrangement, as claimed in claim 1, wherein the objective is to ensure the de-energization of the load current circuit (LN), said circuit arrangement comprising:
a first electromagnetic relay (K1) having a first switch (k1),
a second electromagnetic relay (K2) having a second switch (k2),
a first switch position indicator circuit (A1),
a second switch position indicator circuit (A2), and
an evaluation circuit, which compares the command inputs of the relays (K1, K2) with the current states of the indicator circuits (A1, A2) and from said comparison derives the state of the circuit arrangement as “faultless” or as “defective.”

4. The circuit arrangement, as claimed in claim 3:
wherein the monitoring circuit includes integrated circuits, which are assigned to the respective evaluation circuits (A1, A2), and also includes additional logic circuits, in order to evaluate for agreement the positions of the relay switches (k1, k2) in relation to each other,
wherein in the faultless active state the first and second switches (k1, k2) close the load current circuit (LN) and open the respectively associated indicator circuit (A1, A2), which is manifested by means of the non-responsiveness of the current detection means,
wherein a state “hanging contacts” at one of the relays allows the assigned indicator circuit (A1, A2) to remain in its state prior to the de-energization of the load current circuit (LN), a situation that can be evaluated as a fault state of the relevant relay,
wherein a fault state “three point contact bridge” becomes apparent due to the partial response of the current detection means of the defective relay, when the load current circuit (LN) is connected up, and
wherein a fault state “two point contact bridge” at one of the relays does not allow the current detection means of the assigned indicator circuit to respond or allows only a weak response of said current detection means, when the relays are brought into the circuit.

5. The circuit arrangement, as claimed in claim 1, wherein the objective is to ensure the energization of the load current circuit, said circuit arrangement comprising:
a first electromagnetic relay (K1) having a first switch (k1),
a second electromagnetic relay (K2) having a second switch (k2),
a first indicator circuit (A1),
a second indicator circuit (A2), and
an evaluation circuit, which compares the command inputs of the relays (K1, K2) with the current states of the indicator circuits (A1, A2) and from said comparison derives the state of the circuit arrangement as “faultless” or as “defective.”

6. The circuit arrangement, as claimed in claim 5:
wherein the monitoring circuit includes integrated circuits, which are assigned to the respective evaluation circuits (A1, A2), and also includes additional logic circuits, in order to evaluate for agreement the positions of the relay switches (k1, k2) in relation to each other,
wherein in the faultless active state both the first and the second switches (k1, k2) close the load current circuit (LN) and open the respectively assigned indicator circuit (A1, A2), which is manifested by means of the non-responsiveness of the current detection means,
wherein a state “hanging contacts” at one of the relays allows the assigned indicator circuit to remain in its state prior to switching over the load current circuit (LN), a situation that can be evaluated as a fault state of the relevant relay,
wherein a fault state “three point contact bridge” becomes apparent due to the partial response of the current detection means of the defective relay, when the load current circuit (LN) is energized, and
wherein a fault state “two point contact bridge” at one of the relays allows the current detection means of the assigned indicator circuit to respond intensively, when the other relay is switched into the idle state.

7. The circuit arrangement, as claimed in claim 1, wherein the current detection means are designed as light emitting diodes (LED1, LED2), which are arranged in series with a respective auxiliary voltage source (H1, H2) and with two (G1,Ö1; G2,Ö2) of the three contact points (S1, G1,Ö1; S2, G2,Ö2) of a respective relay (K1, K2).

8. The circuit arrangement, as claimed in claim 3:
wherein a first auxiliary voltage source (H1) of the first indicator circuit (A1) includes a first transformer (T1), to which a current/voltage pulse can be intermittently applied, and
wherein a second auxiliary voltage source (H2) of the second indicator circuit (A2) includes a second transformer (T2), to which a current/voltage pulse can be intermittently applied.

9. The circuit arrangement, as claimed in claim 8, wherein the first and second transformers (T1, T2) are structurally combined and form a transformer having a common primary winding and two secondary windings.

10. The circuit arrangement, as claimed in claim 3, wherein the first and the second electromagnetic relays (K1, K2) are connected to a control current circuit.

11. The circuit arrangement, as claimed in claim 1, wherein an optocoupler connects the respective indicator circuit (A1) to the respective evaluation circuit.
